(19) United States
(12) Patent Application Publication
(10) Pub. No.: US 2026/0040358 A1
(43) Pub. Date: Feb. 5, 2026

(54) AIOT – METHODS FOR RANDOM ACCESS ROBUSTNESS

(71) Applicant: INTERDIGITAL PATENT HOLDINGS, INC., Wilmington, DE (US)

(72) Inventors: Martino Freda, Laval (CA); Erdem Bala, East Meadow, NY (US); Paul Marinier, Brossard (CA); Jongwoo Hong, New York, NY (US); Remun Koirala, London (GB); Ahmed Mostafa, Ottawa (CA); Aata El Hamss, Laval (CA); Patrick Tooher, Montreal (CA)

(73) Assignee: INTERDIGITAL PATENT HOLDINGS, INC., Wilmington, DE (US)

(21) Appl. No.: 18/794,677

(22) Filed: Aug. 5, 2024

(51) Int. Cl. H04W 74/0833; H04W 68/02

(52) U.S. Cl. CPC H04W 74/0833; H04W 68/02

(57) ABSTRACT

Methods and devices are disclosed contention resolution of Ambient Internet of Things (AIoT) devices. In one example, a wireless transmit receive unit (WTRU) receives, from a network, configuration information including a threshold number of devices to be queried, at least a first random ID size and a second random ID size. The WTRU selects a random ID size for an RA procedure based on a number of devices expected to respond to a query and a number of configured query occasions, and sends a paging message to one or more devices to be queried, indicating the selected random ID size. The WTRU may then receive, from the one or more devices, a first message including a device-selected random ID corresponding to the indication of the selected random ID size. The WTRU may further determine whether to increase the random ID size for a next configured query occasion.

### BACKGROUND

Ambient Internet of Things (AIoT) is a subject of study based on the increased popularity of IoT. In recent years, IoT has attracted significant attention in the wireless communication world and more ‘things’ are expected to be interconnected for improving productivity, efficiency and increasing comforts of life. Further reduction of size, complexity and power consumption of IoT devices can enable the deployment of tens or even hundreds of billions of IoT devices for various applications and will provide added value across the entire value chain. It is impossible to power all the IoT devices by batteries that require manual replacing or recharging, which leads to high maintenance cost, serious environmental issues and even safety hazards for some use cases, e.g., wireless sensors used in electric power and petroleum industries.

Considering the limited size and complexity required by practical applications for battery-less devices without energy storage capability or devices with limited energy storage that do not need to be replaced or recharged manually, the output power of a typical ambient energy harvester is from 1 μW to a few hundreds of μWs. Existing cellular devices may not work well with energy harvesting due to their peak power consumption of higher than 10 mW.

In new radio (NR), random access (RA) includes a preamble transmission (MSG1), a response by the network to the received preamble (MSG2), common control channel (CCCH) service data unit (SDU) transmission by the user equipment (UE) (MSG3), and final contention resolution (MSG4). Contention (i.e., uncertainty due to potential selection by multiple UEs of the same preamble) resolution is achieved by the transmission of both MSG2 and MSG4.

In AIoT, a 4-step random access procedure would be too expensive for devices from a power consumption perspective. For this reason, the baseline assumption is that MSG2 resolves all cases of contention. Specifically, it is assumed that the probability of two devices selecting the same resource for transmission of MSG1 as well as selecting the same random device ID to be included in MSG1 transmission is close enough to zero that it can be effectively ignored. Solutions are needed for RA by AIoT devices to ensure there is no contention without significantly impacting UE transmit power.

### SUMMARY

In certain aspects, a UE, also referred to herein as a wireless transmit receiver unit (WTRU), determines the size of the ID to be used in MSG1 transmission of an RA procedure by a device, based on the number of devices to be paged and results of previous random access procedures, and transmits the determined ID size in a paging message.

In one example, a WTRU receives a configuration for determining a random ID size and adjustment thereof, from the network. Examples of the configuration information received may indicate one or more of, a threshold number of devices to be inventoried, a first random ID size, a second random ID size, a set of N threshold number of random access failure events and/or an amount of random ID size increase.

According to one aspect, the WTRU selects a random ID size to be used by queried devices in a random access procedure, based on the number of devices expected to respond and/or the number of configured query/inventory occasions: For example, if the number of devices to be paged is above a threshold, the WTRU selects the first configured random ID size, otherwise the WTRU selects the second configured random ID size. Additional or alternative examples used in determining/selecting the random ID size may be based on one or more previous inventories, the number of known (e.g., already inventoried) devices, and/or the different types of devices being queried.

The WTRU sends/indicates, e.g., in a paging message, the selected random ID size to be used by the queried devices and receives at least one device transmission (i.e., AIoT MSG1) containing a device-selected random ID corresponding to the indicated selected random ID size.

In various aspects, the WTRU may determine whether to increase or decrease the random ID size for the next configured query occasion, based on random failure metrics measured up to the current occasion. For example, if the cumulative number of failed random accesses (e.g., number of received MSG1 transmissions for which the WTRU does not respond (e.g., with RA MSG2) exceeds a configured threshold). In optional aspects, the random ID size may also be decreased based on various factors such as RA procedure successes, actual number of responding devices, etc. The WTRU may then indicate, to the devices, an increase/decrease by a configured amount in the random access ID size for the next inventory occasion.

According to other aspects, methods and AIoT devices are disclosed for randomly selecting a device ID based on an indicated random ID size. In one aspect, a method may generally include receiving, via a wireless transmission from a reader device, an indication of a first random ID size for a random access (RA) procedure. The AIoT device selects a random device ID based on the received indication of the first random ID size and indicates, via a wireless transmission to the reader device, the selected random device ID in a first RA message (MSG1) of the RA procedure. In another aspect, the AIoT device may receive, from the reader device, an indication of an increased/decreased random ID size for a further RA procedure. The AIoT device selects a new random device ID based on the received indication of the increased/decreased random ID size and indicates, to the reader device, the selected new random device ID in a first RA message of a subsequent RA procedure. Additional and/or modified embodiments are disclosed hereinafter.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates and example inventory procedure using a radio frequency identification (RFID) interrogator and RFID tag;

FIG. 3 is an example network diagram of a first topology with an Ambient Internet of Things (AIoT) device communicating directly with a base station;

FIG. 4 is an example network diagram of a second topology with an AIoT device communicating with an intermediate node that communications with a base station;

FIG. 5 is an example network diagram of a third topology with an AIoT device transmitting data/signaling to a base station and receiving data/signaling from an assisting node (i.e., downlink assistance);

FIG. 6 is an example network diagram of the third topology with an AIoT device receiving data/signaling from a base station and transmitting data/signaling through an assisting node (i.e., uplink assistance);

FIG. 7 is an example network diagram of a fourth topology where an AIoT device communicates bidirectionally with a WTRU;

FIG. 8 illustrates and example AIoT random access messaging framework;

FIG. 9 is a flow diagram detailing an example method for use by a wireless transmit receive device (WTRU) in determining a size of a device ID used by queried devices in MSG1 transmission of a random access procedure according to one embodiment; and

FIG. 10 is a flow diagram detailing an example method by a queried device such as an AIoT device according to an embodiment.

### DETAILED DESCRIPTION

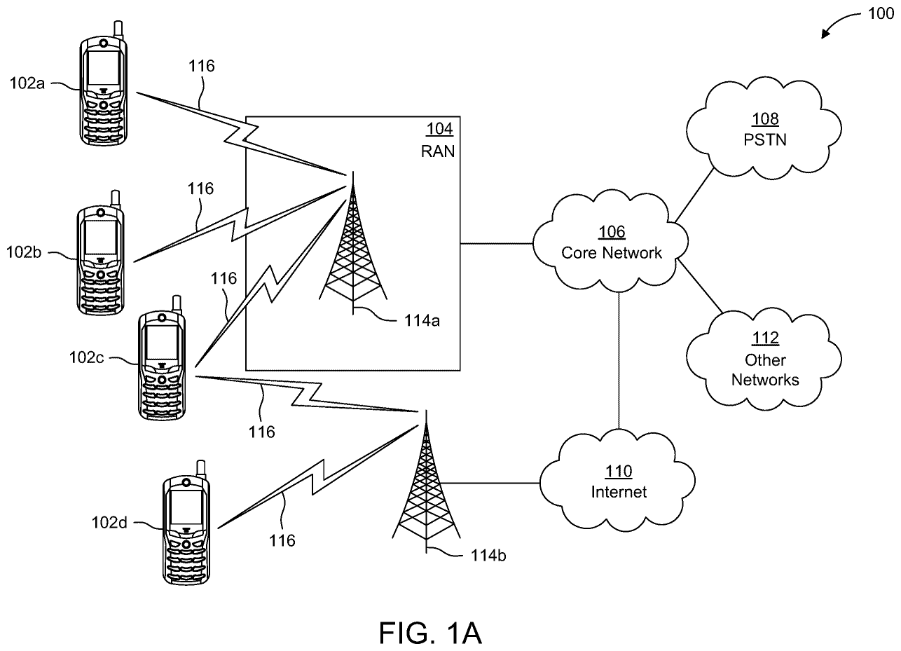

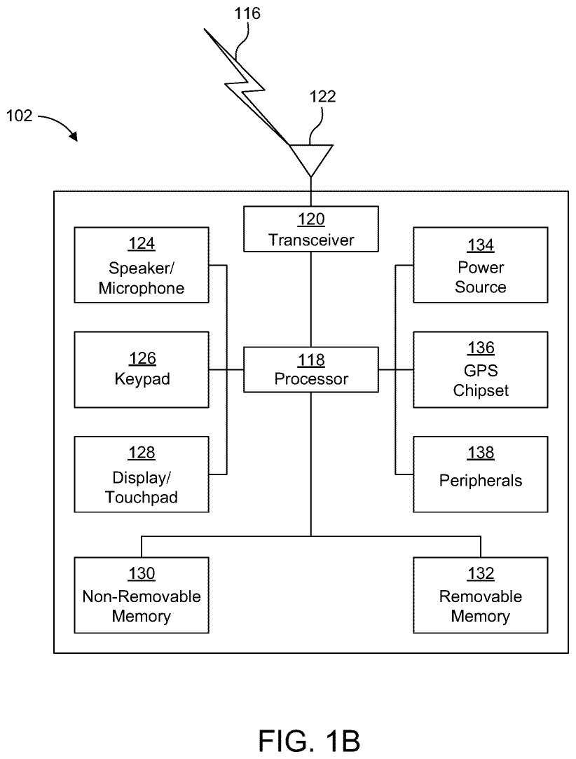

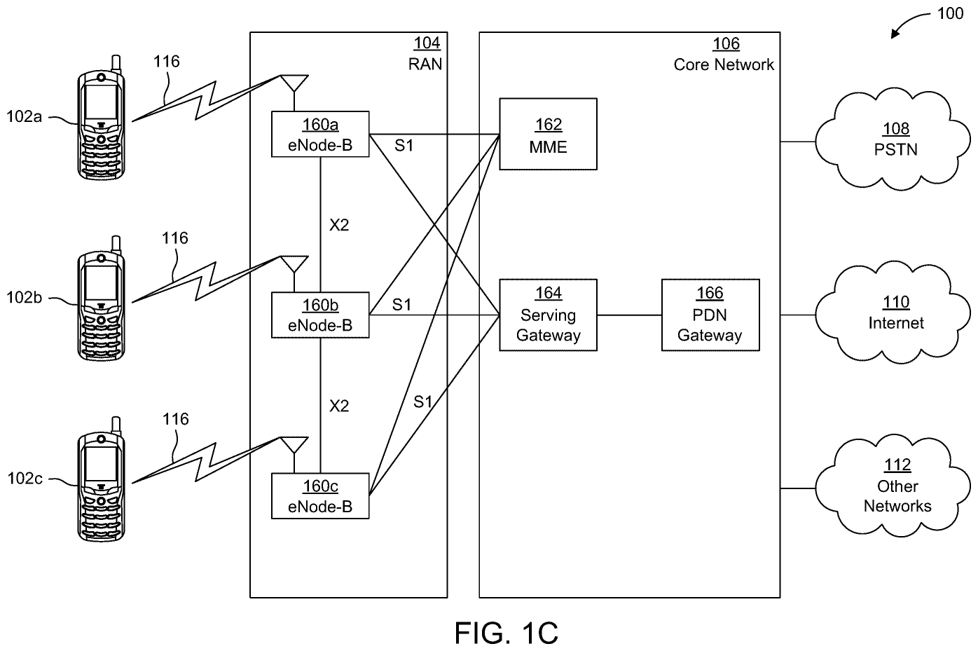

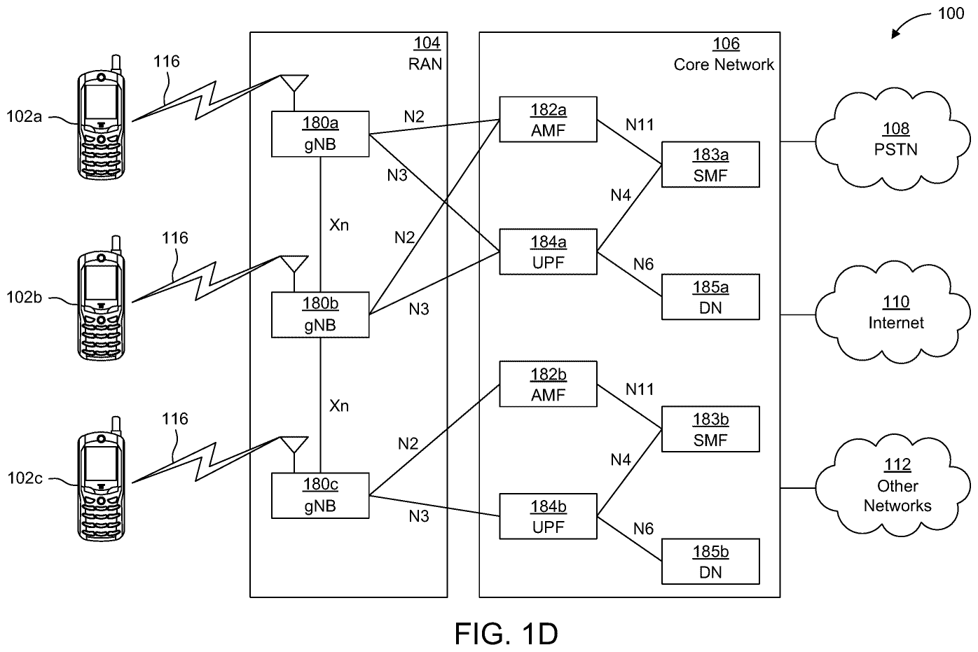

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11 ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11 ah. The channel operating bandwidths, and carriers, are reduced in 802.11af and 802.11ah relative to those used in 802.11n, and 802.11 ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11 ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11 ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11 ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

As previously mentioned, in recent years, IoT has attracted much attention in the wireless communication world. More ‘things’ are expected to be interconnected for improving productivity efficiency and increasing comforts of life. Further reduction of size, complexity, and power consumption of IoT devices can enable the deployment of tens or even hundreds of billions of IoT devices for various applications and provide added value across the entire value chain. It is impossible to power all the IoT devices by batteries that need to be manually be replaced or recharged, which incur high maintenance costs, serious environmental issues and even potential safety hazards for some use cases such as wireless sensors in electric power and petroleum industries or the like.

Considering the limited size and complexity required by practical applications for battery-less devices with minimal or no energy storage capability that do not need to be replaced or recharged manually, the output power of an ambient IoT device energy harvester is typically from 1 μW to a few hundreds of μW. Existing cellular devices may not work well with energy harvesting due to their peak power consumption of higher than 10 mW.

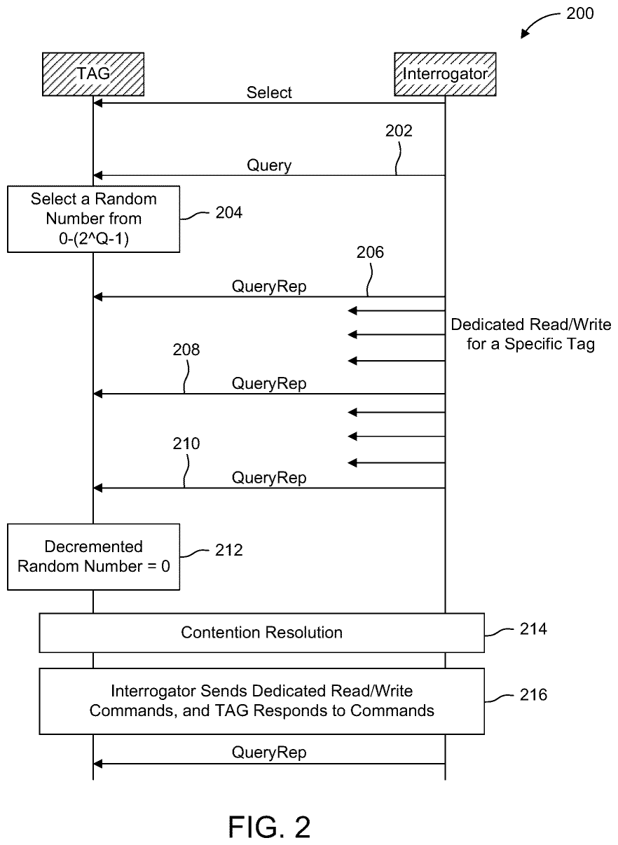

Radio frequency identification (RFID) has typically been used for applications of asset identification and/or tracking. Referring to FIG. 2, an example inventory procedure 200 for RFID is shown. In inventory procedure 200, an interrogator sends 202 a Query message to energize all, or a subset of, RFID TAGs, also referred to as an RF TAG or simply TAG. Following a Query message 202, a TAG selects 204 a random number, e.g., from 0-2\hat{ }Q−1, where Q is a number of query occasions, and loads its memory with the random number. At each transmission 206, 208, 210 of a QueryRep, the TAG decrements its counter/stored random number until it reaches 0, e.g., at point 212 in FIG. 2. When the TAG counter reaches 0, the TAG initiates a contention resolution procedure 214, which includes the TAG transmitting its device ID in the uplink, and waiting for confirmation of the device ID in the downlink (to address possible collision between multiple devices selecting the same random number). For a device that has passed contention resolution, at step 216, the Interrogator can send one or multiple read/write commands, to which the TAG should respond.

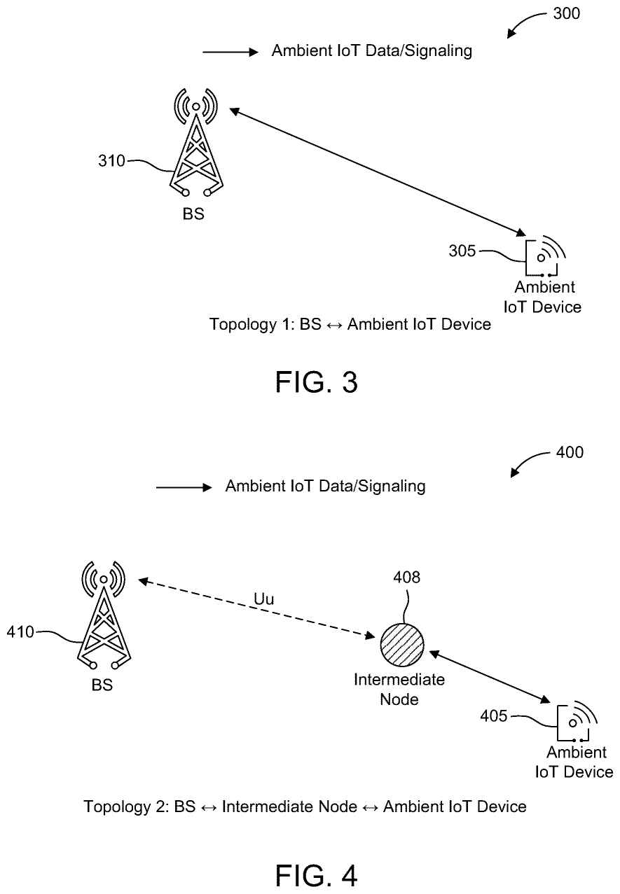

In recent 3GPP efforts, topologies were defined for various AIoT deployment and data/signaling scenarios. Referring to FIG. 3, an example network topology 300, e.g., referred to as Topology 1, is shown for an Ambient IoT device 305 to directly communicate with a base station (BS) 310, e.g., bidirectionally. The communication between the base station 310 and the ambient IoT device 305 includes Ambient IoT data and/or signalling. Topology 300 includes the possibility that the BS transmitting to the Ambient IoT device 305 is a different from the BS receiving from the Ambient IoT device 305.

Referring to FIG. 4, another example network topology 400, e.g., referenced as Topology 2, is shown in which an Ambient IoT device 405 communicates with a base station 410 via an intermediate node 408 between AIoT device 405 and base station 410. In topology 400, the intermediate node 408 can be a relay node, an integrated access and backhaul (IAB) node, a UE/WTRU, a repeater, etc., which is capable of Ambient IoT communication. The intermediate node 408 transfers the information to and from BS 410 and AIoT device 405.

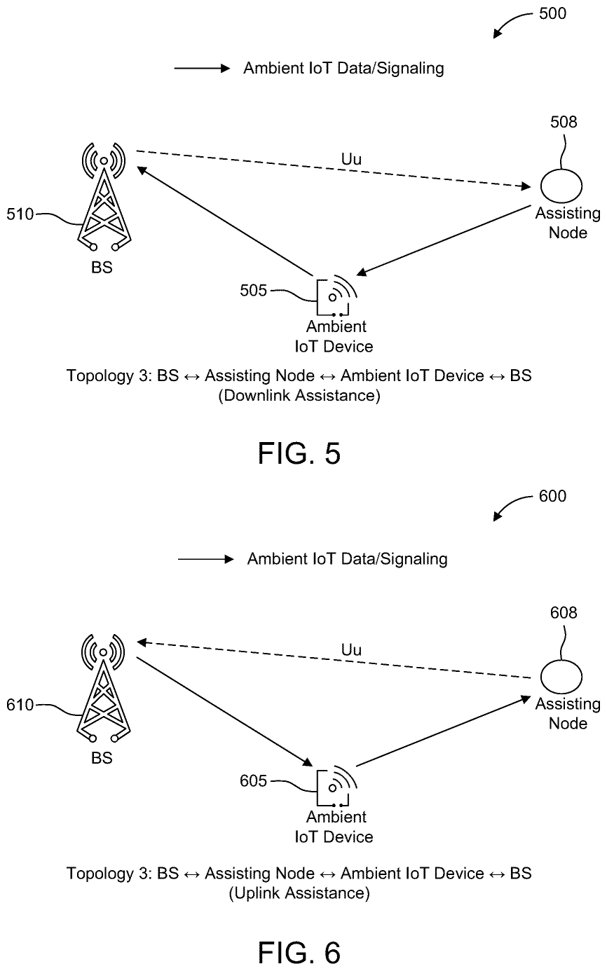

In FIG. 5 and FIG. 6, other example network topologies 500 and 600, collectively referenced as Topology 3, are shown. FIG. 5 network topology 500 and FIG. 6 topology 600 are similar by including respective assisting nodes 508 and 608, to facilitate assistance for transmissions in either downlink or uplink communication for the AIoT device.

For example, in FIG. 5 network topology 500, AIoT device 505 transmits data/signalling directly to base station 510, but receives data/signalling from BS 510 through assisting node 508. In FIG. 6 network topology 600, AIoT device 605 receives data/signalling directly from a base station 610 but transmits data/signalling to BS 610 through the assisting node 608. In Topology 3, the assisting node can be a relay node, an IAB, UE/WTRU, repeater, etc. which is capable of ambient IoT communication.

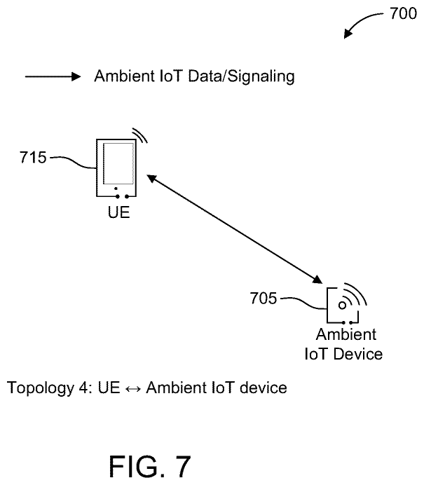

Referring to FIG. 7, yet a further network topology 700, referred to as Topology 4, is shown in which in AIoT device 705 communicates bidirectionally with a WTRU 715. The communication between WTRU 715 and the AIoT device 705 includes AIoT data and/or signalling.

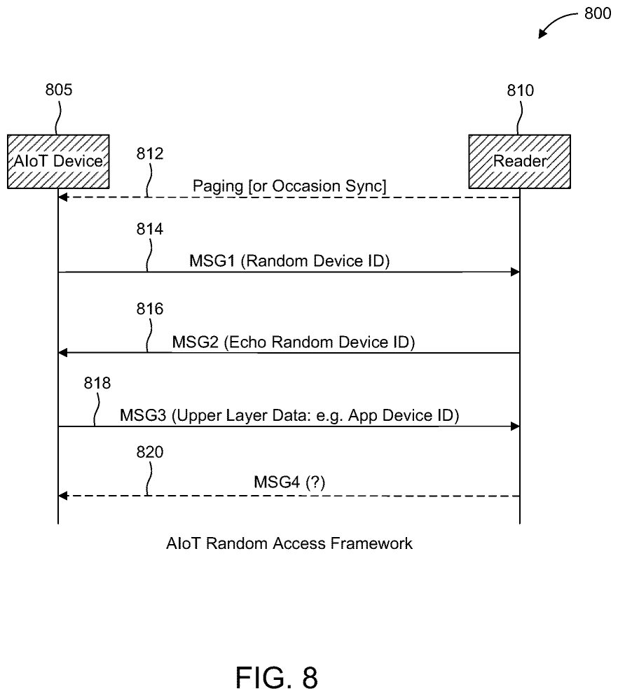

Turning to FIG. 8, an example AIoT random access framework 800 is shown for messaging between an AIoT device 805 and a device reader 810. The reader sends 812 a paging message and a set of occasion synchronization messages which respectively provides the device IDs of the devices to respond and configures/delimits the random access occasions for transmissions by the AIOT devices 805. The AIOT device 805 selects an occasion (using at least slotted ALOHA as the baseline), and transmits 814 a random device ID in MSG1. Reader 810, upon successful reception of MSG1, transmits 816 MSG2 by including the received random device ID in MSG2. If AIoT device 805 receives the echoed random device ID in MSG2, it transmits 818 MSG3 which contains upper layer data (e.g., an application layer device ID). MSG4 may be transmitted 820 by the reader (e.g., for subsequent command transmission), but the understanding is that contention is already resolved at MSG2 transmission.

Random access in NR includes use of a preamble transmission (MSG1), a response by the network to the received preamble (MSG2), common control channel (CCCH) service data unit (SDU) transmission by the WTRU (MSG3), and final contention resolution (MSG4). Contention (i.e., uncertainty due to selection by multiple WTRUs of the same preamble) resolution is achieved by the transmission of both MSG2 and MSG4.

In AIoT, a 4-step random access procedure would be too expensive for devices from a power consumption perspective. For this reason, the baseline assumption is that MSG2 resolves all cases of contention. Specifically, it is assumed that the probability of two devices selecting the same resource for transmission of MSG1 as well as selecting the same random device ID to be included in MSG1 transmission is close enough to zero that it can be effectively ignored. Embodiments are disclosed herein to ensure there is no contention without significantly impacting WTRU transmit power.

Device terminology. In following embodiments, the terms device, AIoT, WTRU and TAG may be used interchangeably to mean an AIOT device that is being inventoried/queried by the reader. The term reader refers to the entity which queries the AIOT device, either directly, or via an intermediate WTRU such as shown in topology 2. The term reader in topology 2 may also refer to the intermediate WTRU. As a result, the term reader may refer to a network node or a WTRU, depending on the context and/or the topology. In this disclosure, the terms reader, network and/or intermediate WTRU, may be interchangeably used to mean the reader. This results in a tradeoff between the number of resources for random access, the size of the random ID (i.e., the number of unique IDs that can be selected is based on the size of the random ID) and/or the power consumption associated with the devices. Specifically, a large number of resources is not preferable because it increases the time required for the query procedure. The time can be shortened by using less resources and increasing the size of the random ID. However, larger sizes of the random ID will result in increased power consumption by the devices being queried. If a same size of the random ID is used in all cases, the system may consume device power unnecessarily.

Inventory Terminology. In the described embodiments, inventory generically refers to the overall procedure of a reader triggering access by multiple devices using a sequence of messages (e.g., similar to query, followed by query rep in RFID). Specifically, the inventory procedure refers to a single round of attempts to have each device respond or attempt to respond with its access ID, or perform a random access channel (RACH) procedure. Specifically, the inventory procedure refers to a set of access occasions which may have 0 or at least 1 device respond within the access/query/inventory occasion. As described herein, an inventory or query procedure may be similar to a legacy RFID procedure. Although referred to herein as inventory procedure, it may be termed differently in device requirements or specifications (e.g., query procedure, paging procedure, etc.) and is not intended to limit the embodiments to any particular purpose or application.

Occasion Terminology. As used herein, occasion refers to the opportunity for device transmission that may be delimited by the transmission of a query rep message (or similar). Specifically, a device may perform transmission in an occasion by performing a AIoT transmission in a defined time following a query rep associated with that transmission. Alternatively, an occasion may consist of both a time aspect and a frequency aspect. Specifically, a device may determine an occasion as a transmission following a specific query rep, and by transmitting on one of a number of frequencies (e.g., frequency division multiplexing (FDM)). Wherever solutions described herein indicate selection of an occasion, they can apply equivalently to selection of only a time component and/or selection of a frequency component.

Time reference. Depending on the solution or description, any reference to time can be associated with an absolute time measurement (e.g., seconds, slots, frames, etc.). Alternatively, time can refer to a number of executions of a procedure, possibly triggered by a reader (e.g., a number of inventory procedures, a number of accesses or RACH procedures, etc.). Alternatively, it can refer to a number of messages, possibly of a specific type, or containing specific information, as described herein, received or transmitted.

Configuration terminology. As used herein, configuration or pre-configuration may refer to any configuration received by a message (e.g., a radio resource control (RRC) message, a medium access control (MAC) control element (CE), a physical (PHY) layer signal, a data packet data unit (PDU), a control PDU associated with any or a new protocol layer, etc.) received from either a network node or from another device or WTRU. A device herein may be configured by the reader, whereby the reader may be a network node or a WTRU (e.g., intermediate WTRU in topology 2). In the case of a WTRU, the WTRU may derive the device configuration itself, or receive the device configuration from the network, in which case, the device configuration is being relayed from the network to the device by the WTRU. On the other hand, a WTRU configuration (in the case of a WTRU in topology 2) may be received from a network node (e.g., the gNB).

Resource Terminology. As used herein, the term resource (when referring to the AIoT interface) can refer to at least any of: (i) a time/frequency resource in the traditional sense; (ii) a frequency resource which may be available at different times; and/or a time resource (possibly limited to one or more frequencies or frequency ranges) which starts from the transmission of a reader message and which lasts either a maximum period of time, or until the next transmission by the reader, possibly of a specific message.

As described in the embodiments, an echo of MSG1 may include a transformed value of the device ID in MSG1. In the solutions described herein, MSG1 echo is transmitted in MSG2 for the device being queried to determine whether contention is resolved. The basic assumption is for MSG2 to contain at the same contents of the device-selected random ID in MSG1. However, solutions where MSG2 is a known function or transformed value of MSG1 may also be considered. For example, MSG2 may be generated by performing a known function (e.g., encryption, security transformation, etc.) which is known to both device and reader. Alternatively, MSG2 may contain only a subset of the MSG1 random ID. Alternatively, MSG2 may contain multiple repetitions of MSG1. Other options are possible and the embodiments described herein with respect to responding to MSG1 with an echo of the random ID are not limited in this respect.

Unless otherwise indicated (or clear from context due to, for example, the message number being referenced), the solutions below can be applicable to both “4-step” like random access, where data is not sent in the first message, and “2-step” like random access, where data is sent in the random access.

Embodiments described herein discuss the determination of the MSG1 transmission size at the MAC layer (i.e., the number of bits which may be used for the device-selected random ID).

However, facets of the disclosed solutions may be alternatively, or additionally, applied to other aspects of the MSG1 transmission. Specifically, a MSG1 transmission aspect for the disclosed solutions may include (and hence, the solutions discussing MSG1 size may be replaced or supplemented with) any one, or a combination, of the following:
L1 preamble length;
Preamble/midamble/postamble structure (e.g., whether to include midamble and/or postamble);
Max/min/actual over the air transmission duration;
Frequency and/or time and/or sync/occasion resource for MSG1 transmission (for example, this may refer to the number of frequency resources, the number of time resources, the number of occasion resources, etc., which a device may select from and/or whether to restrict transmission to specific (subset of) time/frequency resources);
MSG1 transmission power;
Number of repetitions of message 1 (e.g., possibly within the same occasion or over different occasions within a single inventory procedure);
Type of identity to transmit in MSG1 (for example, this may include deciding whether to transmit a random ID, a device ID, a partial device ID, etc., or may define which of a multitude of device IDs maintained by the device that should be transmitted in MSG1);
Whether to include the random ID with MSG1 transmission or not;
If a cyclic redundancy check (CRC) is added to MSG1 and/or the size of the CRC if it is added; and/or
The data rate with which MSG1 is transmitted where the data rate may depend on at least the duration of a bit.

In various embodiments, a reader may determine an appropriate parameter or transmission aspect relevant to initial random access transmission by a device (i.e., MSG1). The reader may determine the aspect or transmission parameter to be used for an inventory/query, for a specific occasion/resource (or set of resources) where access can be attempted by one or more device, for a specific device or class of devices, or for a specific access type. A reader may then indicate the parameter or transmission aspect to the devices to be queried prior to their access.

In one example, the reader device may provide the value of the parameter or transmission aspect in a paging message or the message which precedes the inventory procedure. For example, the reader may provide the value of the parameter or transmission aspect in the sync/occasion message used to delimit the time-based occasions. For example, the sync/occasion message may be similar to the queryRep message in RFID to delimit the access occasions at the device. For example, in the case of multiple frequency access by devices, the sync/occasion message may delimit a number of separate frequency occasions which may occur at the same time (one transmission per frequency at the device).

In one embodiment, a device may transmit a random ID in MSG1. Prior to this, the reader may determine the size of the random ID to be selected by the device (i.e., the number of bits or ID space of the random ID) based on any one, or combination, of the factors 1-8 discussed below.

(1) Number of devices expected to respond/to be paged. In one solution, the reader may determine random ID size to be used based on the number of devices to be paged. By way of example, this may be determined by the range of paging ID or the number of devices in which the paging ID is referencing, whereby the paging ID is received by the reader in the inventory command (and possibly transmitted in the AIoT paging message to initiate the access). For example, if the paging ID is a bit mask which references a number of devices with unique IDs, the number of IDs may be determined by the number of unique IDs.

In another example, the random ID size may be determined by the number of devices which are known to respond to a specific paging ID, either from a databased of currently maintained device IDs, or from previous responses to a similar/same paging message. For example, a reader may determine the number of devices corresponding to a paging ID (as described herein) and may further determine the number of devices to be paged as the number of devices identified in the paging ID which are furthermore being maintained or accessed by the reader (e.g., based on a table). In an example, a reader may determine the number of devices being paged as the number of devices which responded to previous paging message/inventory when using the same paging ID. Another example, the random ID size may be determined by the size of the paging ID, paging mask, or number of paging IDs to be transmitted in the paging message.

In another example, a reader may determine the random ID size based on some network configured rules associated with the number of devices being paged. In one embodiment, the reader may be configured with a first random ID size (x bits) to be used with a first range of number of device IDs (e.g., x1 devices to x2 devices), a second random ID size (y bits) to be used with a second range of device IDs (e.g., y1 to y2 devices), and so on. For example, the reader may be configured with a first random ID size (x bits) to be used with a first range of paging ID/mask size, a second random ID size (y bits) to be used with a second range of paging ID/mask size, etc.

According to another example, the random ID size may be determined by the format of the paging ID received from upper layers. For example, the reader may be configured with a first random ID size to be used with a first format of the paging message and a second random ID size to be used with a second format of the paging message.

(2) Number of occasions/resources configured for access. In one solution, a reader may determine the size of the random ID based on the configured or determined number of occasions and/or number of time/frequency resources associated with random access, possibly for one round of the random access (i.e., one paging message), possibly for a subset of resources (e.g., the number of frequency resources associated with one or more time occasions). For example, a time occasion may include the time between two subsequent sync/occasions (or other reader message) sent by the reader and the number of frequency resources associated with such occasion may be used to determine the size of the random ID.

As one example, the reader may be (pre)configured or predefined with a mapping between the number of access occasions configured/selected by the reader and the size of the random ID. For example, the reader may be (pre)configured or predefined with a mapping between the number of access resources (both time/frequency resources) in one access occasion or across multiple access occasions, and the size of the random ID. In another example, as described later herein, the reader may indicate which of the resources after the sync message (or MSG2) are contention free (and are being used for MSG3 transmission) and which are contention based (and can be used for MSG1 transmission). The device may determine the size of the random ID based on the number of resources available for contention-free access.

(3) Results of previous random access (in previous occasion or inventory). In one solution, a reader may determine the size of the random ID based on previous results of the random access, either based on results in the random access in previous occasions/resources of the same inventory, or the access occasions of a previous inventory (i.e., triggered by a previous paging message). The reader may use any one, or combination, of the following measures (i)-(v) with respect to previous access procedures:
(i) Measure of the number of devices which transmitted in MSG1 using the same random ID, or similar (i.e., differing by at most a number of bits) random IDs, Possibly within the same occasion or across different occasions or access resources.
(ii) Measure of the number of devices which initiated access during resources/occasions reserved for failed random access (i.e., no MSG2 received by these devices).
(iii) Measure of the number of resources/occasions where the reader was unable to decode the random identity (e.g., due to transmission by multiple devices).
(iv) Measure of the number of times the random ID size was changed in the past (e.g., in a previous inventory).
(v) Measure of the random ID size used in the previous occasion, or previous inventory. For example, a reader may increase the random ID size by a (pre)configured or predefined number of bits if it detects multiple devices (e.g., at least a preconfigured number) transmitting MSG1 with the same value of the random ID, possibly using the same random ID in the same/different occasions, possibly over a configured or predefined time period.
(4) Type or format of identity used/included in paging may be used to determine a random ID size. In one example solution, a reader may determine the random ID size based on the type or format of the identity used for paging and/or included in the paging message. This may refer to whether a first format of paging ID or a second type of paging ID is used. For example, the reader may be configured with a first size or set of sizes for random ID size for a first type of paging ID (e.g., paging by upper layer ID) and a second size of set of sizes for random ID size for a second type of paging ID (e.g., paging by AS layer ID). Alternatively, this may refer to the format of the paging ID itself, which may include the specific bits of the mask which differ between the devices being paged. For example, paging with a common first part of the device ID may be associated with the use of a first random ID size, and paging with a common second part of the device ID may be associated with the use of a second random ID.
(5) Device type(s) may be used to determine the random ID size. In one solution, a reader may determine one or more device type/types associated with the paging message, either from upper layers, a database, etc., and may determine the random ID size based on the device type. As an example, a reader may be configured with a first random ID size when paging a first device type or set of device types, and a second random ID size when paging a second device type or set of device types. Device types may be defined explicitly (e.g., based on capabilities), or implicitly (based on range of IDs, received power from the devices, etc.).
(6) AIOT topology may be used in determining a random ID size. In one example, a reader may determine the random ID size based on the AIOT topology. For example, for a reader in topology 1, the reader may use a first random ID size, and for a reader in topology 2, the reader may use a second random ID size, and so on.
(7) Reader capabilities (or reader class) for determining random ID size. In one example, a reader may determine the random ID size based on its own capabilities. This may refer to a specific predefined class of readers. This may refer to a specific aspect of device capabilities of the reader (e.g., supported frequencies, supported radio sensitivity, etc.).
(8) Specific resource(s) associated with the access and/or properties of those resources used in determining random ID size. In one solution, a reader may determine the random ID size based on a property of the resource associated with the random access. In various embodiment, this property may consist of any one, or combination, of Length/duration of the resource in time, absolute frequency of the resource, frequency range occupied by the resource and/or a relation of the resource with the Uu resources. For example, whether the resource is UL or DL on the Uu, whether the resource is re-using the Uu resources or is on a non-Uu band and/or whether the resource is adjacent to (in time/frequency, etc.) another transmission by the reader or by the gNB to the reader in DL.

Once determined, the reader may indicate the random ID size to use in the paging message. A device may then use the same random ID size which corresponds to its selected random ID, regardless of the occasion within the inventory controlled by the paging message. Alternatively, a reader may indicate the random ID size to be applied when performing access within a resource (or set of resources). For example, the reader may send the random ID size to be applied in a resource (or set of resources) delimited by a sync/occasion message by the reader, by sending the random ID size within the sync/occasion message. In some embodiments, the reader may send an adjustment (e.g., increase or decrease) to a previously indicated random ID size (indicated in the paging message or a previous sync/occasion message).

A reader may explicitly signal the random ID size in the paging message and/or sync/occasion message. Such explicit signal may be an explicit size, a set of bits associated with a tabulated set of sizes, etc. In alternative solutions, a reader may implicitly signal the random ID size based on characteristics of the paging message or sync message, such as the duration of the message, the frequency (range) of the message, the specific resources of the message, the proximity of the message (e.g., in time) to another transmission (e.g., contention window (CW)), etc.

According to certain embodiments, a reader and/or device determines whether (to instruct the device) to include the random ID. A device may include data in the transmission of MSG1. In some cases, MSG1 transmission containing data from the device (e.g., upper layer ID, upper layer data) may not require transmission of a random ID. In one option, the reader may send some indication (e.g., in paging message) to indicate whether the device should include a random ID (e.g., similar to the indication of the random ID size herein). Alternatively, the device may determine on its own whether to include the random ID or not. Whether to include the random ID may be dictated by one, or a combination, of the following factors (1)-(4).
(1) The amount of data to be included in MSG1, possibly with respect to the required size of the random ID. For example, the required random ID size may be determined to be x bits. If the amount of data to be transmitted in MSG1 is less than x (or a function of x which may be specified or configured), the device may include the random ID. The device may further determine the size of the random ID in such case. Specifically, the device may choose the size of the random ID to ensure that the total message size (data+ID) is (possibly at least) a specific value, where the value may be determined as per solutions herein for determining the random ID size. In a related solution, the device and/or reader may determine to use different message sizes, e.g., a message size for the case where the device transmits data with MSG1 (and possibly a random ID), and a message size where the device transmits only the random ID. The random ID size may then be determined based on these two message sizes and/or whether data is included.
(2) The size of the resource(s) indicated for MSG1 transmission. For example, if the device is able to include both data and random ID in the resources allocated for MSG1, the device may include the random ID, otherwise, it may not include the random ID.
(3) Ability of the device to include the random ID. This factor may be related to the energy available at the device and/or the maximum/minimum transmission duration at the device. In one example, the device may include the random ID along with the data if it has sufficient energy to include the random ID, otherwise it may not. In another example, the device may include the random ID along with the data if the duration of the transmission of device ID and data is smaller than the maximum duration, otherwise, it may include only the data. In a further example, the device may include the random ID along with the data if including both does not result in the device having to include a midamble in the transmission. Otherwise, if the device is able to transmit the data without a midamble, but device ID+data requires a midamble, the device may include only the data.
(4) The type of paging or the type of device ID to be transmitted. In one example, if the paging message (or another reader initiated message) includes an indication for transmitting the random ID along with the data, the device may include the device ID along with the data. In another example, if the paging message is of a first type (where type may refer to any specific format or indication in the control message), the device may include the random ID. In another example, if the paging ID is of a first type (where type may refer to the length of the ID, the format of the ID, what type of ID, e.g., upper layer vs access stratum (AS) layer the ID refers to, etc.), the device may include the random ID, otherwise, the device may not include the random ID.

In an example, the reader may indicate to include the random ID if the reader has context for the specific device(s) being paged. In an example, the reader may indicate to include the random ID if the reader needs to update the AS layer IDs associated with the devices being paged. In another example, the reader may indicate to include the random ID based on similar conditions herein on determining the size of the random ID

In various embodiments, the device, as opposed to the reader, may determine the size of the random ID. The size of the random ID may be a size from a group of pre-configured or specified sizes. For example, the reader may indicate to the devices possible random ID sizes S1 bits and S2 bits and a device may choose which size to use. A device may determine the size based on one or more of aspects, parameters, features of the transmission. One aspect may be the data rate. For example, if the data rate is below a value the device may determine to send an ID with size S1 and if the data rate is above the value, the device may determine to send an ID with size S2. Other aspects may be whether the device is configured to perform repetitions, whether it is an initial transmission or a retransmission. For example, the device may use S1 in an initial transmission, and S2 in a retransmission.

In certain embodiments, AIoT devices may determine an aspect relevant to MSG1 transmission. In one family of solutions, a device may initiate MSG1 transmission in AIoT random access using a transmission aspect indicated by the reader (as described herein). For example, a device may have a mapping of a transmission aspect (i.e., size of the random ID) to a specific property of the paging message (e.g., time duration of the paging message), and may select its random ID using a number of bits corresponding to the determined/configured size. Such a configuration may be predefined in the device or the configuration may be received from the reader or the network in a control message.

In one family of solutions, an AIoT device may itself determine the MSG1 transmission aspect based on similar/same criteria described for reader-determinate case. Such solutions can be extended from those described herein and are therefore not repeated.

In certain embodiments, an AIoT device may select multiple resources (occasion and/or frequency resources) for performing random access. Upon reception of paging, a device may select an occasion and/or a frequency (i.e. FDM) resource within an occasion in which to initiate the MSG1 transmission. The MSG1 transmission may fail for one or more reasons when it is performed on the selected resource. As a result, a device may repeat or re-initiate the random access, possibly in the same inventory procedure on another resource.

The following discussion relates to various failure conditions in random access which may be relevant to the embodiments. A device may re-initiate a random access procedure and/or MSG1 transmission due to any of the following conditions (1)-(6).
(1) Absence of MSG2 reception after transmission of MSG1. As an example, when a device does not receive MSG2 containing the same random ID provided in MSG1 (e.g., a missing or different echoed random ID), within a configured or defined period of time following transmission of MSG1. Another example, is when a device does not receive MSG2 containing the same device ID provided in MSG1 in a predefined resource (e.g., frequency resource) associated with MSG1 transmission (such association being preconfigured or predefined). A further example may be a device receives MSG2 containing a different device ID provided in MSG1 in a predefined resource associated with MSG1 transmission. A further example may be when a device receives an occasion synchronization message from the reader prior to reception of MSG2 containing the same ID provided in MSG1.
(2) Inadequacy of the resource/occasion selected for MSG1 transmission. For example, a device may receive an indication of the resource(s) which can be used for MSG1 transmission for a particular occasion within the sync/occasion message. A device may determine that it is unable to transmit MSG1 within the resource(s) due to the duration of the resource, the frequency or frequency range of the resource, its capabilities with respect to transmitting on that resource, etc. For example, transmission within an occasion may require the device to support FDM, which may not be supported by the device. In another example, the sync/occasion message may indicate for the device to transmit within the occasion using a mode of transmission which is not supported by the device.
(3) Device is unprepared for MSG1 transmission (e.g. due to device energy limitations). For example, a device may be unable to transmit MSG1 because it may be unprepared/unable to transmit MSG1 in a selected resource or occasion. For example, the device may have insufficient energy for MSG1 transmission at the time of occurrence of the selected occasion or resource. By way of another example, the device may not receive a CW or backscattering signal at the time of occurrence of the selected occasion or resource. In a further example, the device may have insufficient energy to perform MSG1 transmission followed by monitoring of MSG2 based on some preconfigured or predefined assumption of required energy for MSG2 monitoring.
(4) Device is unprepared for MSG3 transmission (e.g., due to device energy limitations or memory access delay). In one example, a device may determine it is unprepared to transmit MSG3, possibly following, or possibly prior to, successful reception of MSG2, based on the required energy for MSG3 transmission. In another example, the device may determine it may have insufficient energy to perform MSG3 transmission at the time when it receives the MSG3 resource (e.g., as part of MSG2 reception), or at the time of the MSG3 resource, based on the timing of the MSG3 resource itself and the available energy at the device at the time. In a further example, the device may determine it does not receive a CW signal or a backscattering signal at the time of MSG3 resource (i.e., during the expected transmission time).

As an additional example, a device may determine it is unprepared to transmit MSG3, possibly following successful reception of MSG2, based on the latency associated with accessing the data to be transmitted within the device, and the timing of the allocated MSG3 resource. Specifically, the device may receive a MSG3 resource assignment (e.g., in MSG2) and may determine that the time require to access the data to transmit may be larger than the delay until the start of the MSG3 resource.
(5) Inadequacy of the resource/occasion allocated for MSG3 transmission. For example, a device may not be able to utilize the resource which can be used for MSG3 transmission. A device may determine that it is unable to transmit MSG3 within the resource(s) due to the duration of the resource, the frequency or frequency range of the resource, the device capabilities with respect to transmitting on that resource, the size of the data to be transmitted in MSG3, etc. As an example, transmission within an occasion may require the device to support FDM, which may not be supported by the device. For example, a received sync/occasion message may indicate for the device to transmit within the occasion using a mode of transmission which is not supported by the device. In another example, the size of the data to be transmitted may require a transmission format (e.g., use of mid-amble, post-amble) which is not supported by the MSG3 resource.
(6) Reception and/or contents of MSG4. For example, a device may receive a NACK or error message following MSG3 transmission, indicating the failure of the reader to decode MSG3. In one example, a device may not receive an ACK in a resource allocated for MSG4 reception. In another example, a device may receive a sync/occasion transmission before the reception of an ACK message or a MSG4. In a further example, a device may receive another message than MSG4 (e.g., a command corresponding to a different device) possibly on a resource allocated for MSG4.

Resource/occasion selection criteria according to various embodiments are disclosed. In one family of solutions, a device may perform selection of multiple resources (e.g., multiple occasions, multiple time/frequency resources within an occasion, multiple time/frequency resources over different occasions) for MSG1 transmission. The device may select the occasions upon reception of the paging message. Specifically, the device may receive a configuration of random access resources in the paging message, including information of the number of occasions and/or resources (possibly available, as per discussions herein). The device may perform the selection of the multiple resources upon reception of the paging (or other reader message) based on this information.

In another family of solutions, a device may select a first resource, and upon determination of a failure condition, may select a second resource in the remaining resources. In some solutions, the number of resources selected may correspond to a number of attempts of the random access by a device, for example, within a given inventory procedure. In some solutions, a device may determine a first number of selected resources, but may only use a second number of selected resources to perform actual transmission, where the difference in the number of resources corresponds to occasions where the device does not attempt MSG1 transmission.

Selection of the resources for the multiple transmission (e.g., time/frequency resources) within the set of configured resources (i.e., the resources configured in the paging message) may be performed using any, or a combination, of the following rules:
Fully random selection. For example, selection of each resource for each MSG1 transmission attempt may be performed randomly. Specifically, the device may remove the selected resource from the available resources after the first resource selection and then perform a second random selection for the second resource associated with the second MSG1 transmission, and so on.
Random Selection within the resources occurring after each subsequent resource. For example, selection of the first resource for the first MSG1 transmission may be performed among the entire set of resources. Selection of the second resource for the second MSG1 transmission may occur among the remaining resources which occur after (e.g., in time) the first selected resource, and so on.
Random Selection within a subset of resources each corresponding the specific MSG1 transmission. For example, the device may determine a number of resources to select (i.e., X). The set of resources may be divided (e.g., by configuration or in a predefined fashion) into X subsets. The selection of the first resource for the first MSG1 transmission may be performed among the resources in the first subset, the selection of the second resource for the second MSG1 transmission may be performed among the resources in the second subset, etc. Division of the resources into subsets may be performed based on time (e.g., all frequency resources in a specific time occasion, and a subset consists of a set of time occasions), by frequency (e.g., all time resources associated with a first frequency in the first subset, etc.), by code, etc.
Random Selection with a specified or configured rule which relates the different resources. For example, each of the selected resource should correspond to the same frequency. For example, multiple resources associated with the same time occasion (but different frequency resources) should not be allowed to be selected. In a further example, a minimum number of resources, minimum set of time occasions, etc., should be maintained between a first selected resource and a second selected resource, e.g., selected resources should be separated by at least X occasions (where X can be configured or specified) or selected resources should be separated by at least X opportunities for a MSG2 transmission, where an opportunity for a MSG2 transmission may be associated with the reception of a message (e.g., sync message, a specific one or more types of unicast or broadcast message, etc.) which can carry MSG2.

In the aforementioned solutions, an AIoT device may be configured with rules for the number (min/max) of resources it can select within an inventory procedure (e.g., for each paging message response). A device may determine the number of selected resources based on any one, or a combination, of device capability, parameters provided by the reader or determined at the device, e.g., including total number of resources for random access and/or random ID size of MSG1, energy conditions at the device and/or quality of service associated with the inventory (e.g., some indication of a priority for the random access, either determined by the device or indicated by the reader).

Determining the specific resources selected during (re)attempts may be a consideration in the disclosed embodiments. In one solution, a device which selects N resources may select each of the resources in a random fashion. For example, selection of the first resource may be performed randomly from all resources and selection of the second resource may be performed randomly from the remaining resource, etc. In one example solution, a device which selects N resources may select the first resource randomly. The next resource may be selected randomly, but from the remaining resources occurring after the selected first resource. Such a solution may be applicable to the case where successive selection is performed only after use of the resource (e.g., determination that the random access was not successful).

In one example, a device may select a first resource randomly, and may then select a random offset to determine which subsequent resource to select, where the offset is determined by the number of resources between the previously selected resource and the end of the inventory.

In the case where some occasions may have some unavailable frequency resources (as described elsewhere herein) or the number of frequency resources may differ between occasions, a device may first randomly select a time occasion. Upon the reception of the reader message which defines the available frequency resources, the device may select randomly between the available frequency resources. If the device selects a time occasion where there are no available frequency resources, a device may re-select the next time occasion, until it encounters a time occasion which had at least one (or x) available frequency resources and/or randomly re-selected between the remaining available time resources

In a related embodiment, a device may apply a ratio (e.g., an occupancy factor−less than 1) to the number of frequency resources in a time occasion and may assume the total number of resources across all time occasions (each modulated by the occupancy ratio). The selection may then be performed randomly assuming the modulated number of resources (i.e., an index is determined from the “effective” number of resources where the “effective” number takes into account possible occupancy). The determination of actual resource may be based by counting (using the determined index) where actually occupied resources are not counted.

In another embodiment, a resource may be indicated, by the reader (e.g., in MSG2, a sync message, etc.) as contention-based for initial attempt only, contention-based for re-attempt only, or contention-based for either initial attempt or re-attempt.

Discussion of MSG2 details which may be applicable to the disclosed embodiments are now described.

In certain embodiments, a reader may multiplex multiple MSG1 transmissions from different devices. In one family of solutions, a reader may perform a single transmission of MSG2 which contains responses to multiple MSG1 transmissions, possibly from different devices. Specifically, a reader may indicate N random ID values (or related value, as described herein), where each value is echoing a particular random ID received in a MSG1 from different devices. In one example, a reader may send MSG2 in the occasion sync message broadcast to all devices. In another example, MSG2 may be transmitted prior to the sync message and include one (or a subset of) the echoes of the received random ID values it received in MSG1. Specifically, the reader may transmit a MSG2 for each MSG1 received from a particular device. Alternatively, the reader may transmit a MSG2 for each:
Set of devices having the same device type or device capabilities;
Set of devices having the same length of the MSG1 random ID;
Set of devices having the same received signal power or within the same range of received signal power (e.g., the reader may be configured with different ranges of received signal power of MSG1 and may send all echoed random IDs from the MSG1 that fall within each range using a single response message);
Set of devices having the same or similar MSG1 signal duration (e.g., within a range of MSG1 signal durations, for example, the reader may be configured with different ranges of signal duration of MSG1 and may send all echoed random IDs from the MSG1 that fall within each range using a single response message);
Set of devices transmitting MSG1 with a random ID value within specific ranges (e.g., each MSG2 transmission may contain the echoed values received for the random values that fall in a specific range); and/or
Set of devices transmitting MSG1 in the same time occasion, or set of time occasions (but within different frequency resources). For example, a device may transmit MSG1 in one of a set of frequency resources of a particular time occasion. The reader may respond with a single MSG2 transmission containing all IDs received from MSG1 transmissions within that particular time occasion. For example, a reader may transmit a single MSG2 containing all random IDs received over a fixed/configured number of resources, fixed/configured number of time occasions, within all potential resources which occur between specific occasions that are allowable for MSG2 transmission (e.g., resources configured to allow MSG2 transmission).

In one solution, a reader may determine the number of IDs to respond to in a single message based on any of the following:
Network configuration. For example, the reader may be configured with a maximum size for MSG2 transmission, and may include a number of IDs into MSG2 such that the size of MSG2 does not exceed the maximum size.
MSG1 transmission characteristics (or some function of the MSG1 transmission characteristics of each of the MSG1 transmissions received and requiring a response by the reader), which may include, the length of each MSG1 transmission in time, the received power, the specific preamble sequence, etc. For example, the reader may determine the maximum size for MSG2, or the maximum number of MSG1 transmissions to respond to, based on the maximum/minimum/average received power or length of the received MSG1 transmissions to respond to.
Whether two-step or 3-step random access is being used. For example, the reader may allow multiple MSG1 responses in the same MSG2 only for 3-step random access but not for 2-step access. For example, different configured maximum, or different rules, may be applied to determining the number of multiplexed responses depending on whether 2-step or 4-step is being used.
Whether data/control is included in MSG2. For example, the reader may determine different rules for multiplexing depending on whether/amount of data included in MSG2.

A reader, if the number of MSG1 transmissions to respond to results in exceeding a maximum based on one of the above rules, may send subsequent responses in a different (second) MSG2 transmission.

In another solution, MSG2 transmission may contain a resource index associated with the received MSG1 transmission(s). For example, the reader may include, with each received random ID value, an index of the resource (e.g., for FDM, a frequency index) where the random ID value was received.

In another alternative, MSG2 may contain a bitmap of resources (e.g., for FDM, the set of all frequency resources) associated with the time occasion or period for which MSG2 transmission is occurring. For example, a single MSG2 may be transmitted for all of the time occasions in an inventory. For example, a MSG2 may be transmitted for multiple time/frequency resources (possibly associated with an occasion or the transmission of a sync/occasion message). The reader may transmit a bitmap with a number of bits given by the number of resources, and each bit where MSG1 was received in the corresponding resource would be set to 1 in the transmitted bitmap.

In another alternative, MSG2 may contain a bitmap of all possible combinations of random ID values (where each value corresponds to a bit). The reader may transmit the bitmap, with each bit corresponding to a received MSG1 random ID set to 1.

A reader may transmit MSG2 following any of the following, or a specific or configured time following any of: (i) reception of the first MSG1; (ii) reception of a configured number of MSG1s; and/or (iii) a configured period of time following the reader's transmission of a previous message, where such previous message may be e.g., a paging message, an occasion/sync message or a previously transmitted MSG2 associated with the previous occasion. The configured period of time may further depend on the occasion number (e.g., the larger the occasion, the larger the timer), previous MSG1 receptions from past occasions (e.g., set the time to be a preconfigured amount larger than the longest time period to receive MSG1).

In various embodiments, MSG2 transmission may contain an indication of the resource(s) to be used by a device to transmit MSG3. In one solution, each MSG2 transmission (in the case of responding to a single device with a single message) or random ID value in MSG2 (in the case of responding to multiple devices with a single message) may include resource information, in the form of a frequency index, a resource index, a time/frequency assignment, etc. A device, upon reception of a random ID matching its own transmitted random ID in MSG2, may transmit MSG3 (e.g., device ID and data) in the resource indicated by the corresponding resource.

In another solution, each MSG2 transmission (in the case of responding to a single device with a single message) or random ID value in MSG2 (in the case of responding to multiple devices with a single message) may include an indication of whether to use the same resource or a different resource for transmission of MSG3. Using the same resource may indicate that the device should use the same resource for MSG3 transmission relative to a second reader transmission as was used for MSG1 transmission relative to a first reader transmission. For example, the first reader transmission may be a paging message, a sync/occasion message, or a previous MSG2 transmission by the reader. For example, the second reader transmission may be a subsequent sync/occasion transmission, or the MSG2 transmission. In one example, a device may select a time/frequency resource after the reception of a sync/occasion, whereby such time/frequency resource is associated with a specific index. Upon reception of MSG2 containing an echo of the random ID transmitted in MSG1, and indicating to use the same resource, the device may transmit MSG3 in the resource having the same index as its MSG1 transmission following the MSG2 transmission or following the next sync/occasion message. For example, if no resource indication is included by the reader, the device may have the same behavior as above for selection of the resource. In another alternative, the reader may include an offset or resource change index. The device may change the resource of MSG3 compared to the index of MSG3 by the change index.

In various embodiments, a reader may transmit a subset of the value or data received in MSG1. In some cases, such as for “2-step” like random access, MSG1 may contain actual data or may have both a random ID and data of the device. A reader may select a subset of the contents of MSG1 to transmit in MSG3.

In one example solution, the reader may transmit the first N bits of the contents received in MSG1. In another solution, the reader may transmit the last N bits of the contents received in MSG1. The value of N may correspond to the length of the random ID determined by the reader and transmitted to the device in the paging message (as discussed herein). In another example solution, the contents of the MSG2 may depend on whether a random ID was included in MSG1 (as described herein). If a random ID was included, the reader may transmit the random ID in MSG2, otherwise, the reader may use another solution herein. In a further solution, the reader may transmit either a first set of N bits (e.g., the first N bits) or a second set of N bits (e.g., the last N bits) depending on which set has the most difference in the values between the MSG1 received from the devices. In another solution, the number of bits of the receive MSG1 (i.e., N) may be determined using methods similar to MSG1 length determination as described herein.

Discussion of MSG3 details which may be applicable to the disclosed embodiments are now described.

In some embodiments, an AIoT device may signal a resource request indication and/or indicates (remaining) data size to the reader using MSG3. In one solution, a device may include, instead of (or in addition to) a planned data transmission, an indication of data amount and/or suggested resource for transmission. Specifically, if a device is unable to perform a data transmission at an expected time, or the device is unable to perform full transmission at a given time, the device may transmit such an indication. Indication of resource may refer to an alternative frequency in the next time occasion, a time/frequency resource (e.g. indicated by an index), a future inventory procedure, etc. Such transmission may be performed within MSG3 of the random access procedure or in response to a command issued by the reader.

In one example solution, the resource indication may be in terms of a number of reader messages. Specifically, the device may indicate that is suggests/requests a resource which will come following X reader messages (where such reader messages may be a MSG2, a sync/occasion message, or any message, possibly broadcast or intended to the device in question). It may also refer to a reader message having a specific indication (e.g. broadcast vs unicast resource indication, as per solutions described herein). For example, the resource indication may be a single bit, indicating that the device requests to perform/continue transmission in the next occasion, where the occasion may be a resource that is initiated after the next reader transmission, possibly of a specific type (e.g., containing unicast resource indication).

In one example, the resource indication may contain an offset value which is associated with a number of time/frequency resources or frequency resources only. For example, the indication may instruct the reader that the device intends to transmit in a resource which is offset in time and/or frequency by the indicated number. Offset in frequency may reflect a different frequency resource (e.g., FDM). An offset in time may indicate a different occasion (i.e., based on a sync/occasion message), or the resource associated with one or more messages from the reader (e.g., either MSG2 or a sync/occasion message).

A device may transmit an indication of size (or remaining size) of the data to be transmitted by the device in the next assigned or available resource. The indication may be in terms of absolute size. The indication may be based on a predefined table of bit string to size or size range. The indication may take on one of x different values, where a first value may indicate a resource of a first type is needed to transmit the data, a resource of the second type is needed to transmit the data, etc. The resource type may be indicated in order to influence the reader's next transmission, for example. The resource type may refer to a specific property of the device's transmission and/or a specific property of a resource.

Examples of a specific property of the device's transmission may include:
Whether the transmission by the device is terminated by a postamble, or not (e.g., it has a maximum duration);
A type of postamble used to signal the end of transmission;
Whether a midamble will be used for the transmission or not;
Whether the transmission will be longer than a specific period of time;
Whether the transmission will be split over multiple resources, and the number of resources needed;
Whether the transmission is FDM, code division multiplexed (CDM), etc. (e.g., a resource allocated over the entire frequency band, versus a resource allocated on a single frequency or frequency range); and/or
The device's transmit power.

Examples of a specific property of a resource may include:
Number of frequencies;
Duration or maximum duration; and/or
A resource that requires a contention window (CW) transmission or backscattering signal to be transmitted at the same time.

In one embodiment, a device may transmit, along with the indication, an index of the next selected resource. For example, as discussed herein, if the device performs selection of multiple resources, when a first resource is unusable, the device may indicate the index of another resource which was selected.

Discussion of MSG4 details which may be applicable to the disclosed embodiments are now described.

As used herein, MSG4 is referred to as the subsequent unicast reader-to-device (R2D) (i.e. intended to a single device) transmission to a device following successful random access by a device.

The aspects herein may apply to MSG4 as being the first unicast message. The aspects herein associated to MSG4 may also apply to any unicast message after successful completion of the random access (e.g., any unicast message transmitted to the device in the same inventory procedure, wherein the inventory procedure may be initiated by a paging message and may last until the duration of all access occasions, until a dedicated R2D message, or until the transmission of a subsequent paging message).

In certain embodiments, a reader determines whether to send MSG4. A reader may determine whether to transmit MSG4 or not based on one, or a combination, of the following:
Decoding status of MSG3. For example, if MSG3 is not successfully decoded, the reader may transmit MSG4 to indicate that a retransmission is needed. In this case, upon reception of MSG4, the device may perform a retransmission of MSG3, or a retransmission of a portion of MSG3 only (e.g., the data only). The reader may include an indication of a resource for use by the device to perform the retransmission.
Presence of control signaling along with MSG3. For example, MSG3 may include a resource request indication, a further data to send indication, and/or a remaining data size. If such control signaling is included in MSG3, the reader may perform transmission of MSG4. In one example, if MSG3 includes an indication that more data is to be transmitted by the device, the reader may transmit MSG4 indicating a new resource. In an example, if MSG3 includes an indication that the device was not able to transmit MSG3, the reader may transmit MSG4 indicating a new resource for the device to transmit the initial MSG3 data
Availability of a command to be sent to the device. For example, at the time of MSG3 reception, the reader may determine (e.g., by relating a received ID of the device to a subsequent command to be sent by the reader) that a subsequent command should be sent to the device. The reader may transmit the command in MSG3.

According to some embodiments, a device determines an action related to time based on the reception of R2D messages. In one solution, a device may determine an aspect of time based on the reception of R2D messages. Specifically, such aspect of time may be determined when the device has successfully received one, at least one, or X (configured) R2D transmissions, possibly associated to a specific type (e.g., broadcast type, sync message, unicast type, paging message, etc.). The aspects of time which can be determined based on R2D transmissions may include any, or a combination, of the following:
A hybrid automatic repeat request (HARQ) aspect (e.g., determination of an acknowledgement (ACK), negative ACK (NACK), a time to retransmit, etc.). For example, a device may determine ACK (or NACK) to a device transmission if a number of R2D messages is received following a device transmission.
A resource availability aspect. For example, a device may determine that an assigned/available resource is no longer assigned/available for its transmission after a number of R2D messages are received (possibly after the assignment, possibly after a device transmission, possibly after another R2D transmission, etc.).
Duration of an AIOT procedure (e.g., inventory procedure). For example, a device may consider the inventory procedure completed following MSG3 transmission if MSG4 is not received before reception of another broadcast R2D message (e.g., sync message).
Presence of subsequent procedures (e.g., command procedures). For example, a device may consider that no subsequent commands will be received (e.g., after the reception of a first command) if the device receives at least X messages.
An aspect related to context. For example, a device may use the reception of one or more R2D messages to determine when to release a context-related element, such as a configuration or one or more configuration parameters, an identity, etc. For example, a device may use the reception of one or more R2D messages to determine whether its current configuration can be maintained for a further inventory procedure. For example, if the device receives a certain number of R2D messages, possibly without an explicit indication, the device may store the context for the next inventory procedure.

In various embodiments, a device determines the timing of MSG4 transmission. A device may determine the resource to use for MSG4 transmission based one, or a combination, of the following:
Control element in MSG3. In one example, this may include using the contents of the control message to determine the timing of MSG4. In another example, this may include using a different method (e.g., min, max, fixed/specified/configured) or using a different factor (e.g., device type, amount of data, etc.) to determine the timing of MSG4. In another example, a control element in MSG3 may indicate an implicit or explicit minimum delay to use from the end of MSG3 to the start of MSG4. For example, a control element may take an integer number of values, where each value represents a minimum latency. The device may transmit MSG4 at least following this minimum delay (e.g., the next NR slot which satisfies the minimum delay). In a further example, a control element in MSG3 may indicate additional data to be transmitted. The reader may transmit MSG4 without the need for adding a delay, or may add a fixed/specified or device dependent delay. In yet a further example, upon reception of a first message type (e.g., insufficient energy indication), the reader may transmit MSG4 after a minimum delay, while upon reception of a second message type (e.g., additional data).
Device type. For example, the reader may wait for a minimum or maximum delay following MSG3 reception which depends on the device type. For example, a control element may represent a different minimum latency depending on the device type.
Size of MSG3 transmission. For example, in some cases (e.g., due to the reader being unable to decode MSG3), the reader may use a minimum delay which is a function of the size of the MSG3 transmission. For example, the reader may use a larger minimum delay for a larger MSG3 size.

Reader resource control following MSG2 transmission according to various embodiments is now described. In various embodiments, a reader may indicate a resource/occasion which is contention-based or contention-free. In the case device transmissions are FDM, and reader transmissions are not (i.e., single MSG2 echoing multiple MSG1 transmissions, transmitted over the entire frequency band) solutions are described for how subsequent FDM resources for random access are managed.

In one example embodiment, a reader may transmit one of a sync or occasion indication, a MSG2, a MSG4, or other message, which indicates whether a subsequent resource (e.g., the time starting after the reader message transmission, a slot some time after the reader message, a frequency resource which starts after the reader message, etc.) is a contention-based or a contention-free resource. For example, a reader may include an explicit indication (e.g., a bit which is=1 for contention free or =0 for contention based). In another example, a reader may indicate this based on the message type (e.g., a first type of message may always be followed by contention-based resource and a second message type may always be followed by contention-free resource). For example, a resource after transmission of MSG2 may be considered as contention-free. A resource after transmission of occasions/sync message may be considered as contention-based. For example, a reader may indicate this based on the sequencing of messages. Specifically, there may be predefined rules for determining whether the resource which is started after a message is contention-based or contention-free based on the sequence of messages transmitted by the reader and/or received by the device prior to this.

In another example embodiment, the device may determine whether the resource is contention-free or contention-based based on the contents of the message, possibly in comparison to the contents of a previously transmitted message. For example, such contents may refer to the random ID echoed by MSG2. For example, if a first MSG2 contains a random ID, and a subsequent MSG2 contains the same random ID as the previous MSG2, the corresponding resource after the second MSG2 may be considered as contention-free. On the other hand, if the first MSG2 contains a random ID, and a subsequent MSG2 contains a different random ID, the resource after the second random ID may be considered contention-based.

In various embodiments, MSG1 transmission/random access can be performed on a subset of frequency resources indicated by MSG2. In one specific example, the reader may transmit a sync message or a MSG2 (e.g., over the entire bandwidth) and indicate in the message which frequencies are contention-free and which frequencies are contention-based. In some examples, such indication may be implicit. For example, it may be based on the contents of the sync message or MSG2 message. In one example, it may be indicated by the number of MSG2 echoes corresponding to the different frequencies. For example, a first sync message (e.g., to start a random access occasion) or a paging message may indicate that all frequency resources after the sync message are contention-free resources. A device may select any of the frequency resources after the sync message to transmit MSG1.

A reader may receive multiple MSG1 transmissions over different frequencies. The reader may indicate which frequencies correspond to frequencies where MSG1 was received, and which frequencies correspond to frequencies where MSG1 was not received. These indications for the different frequencies may be sent in the same message (e.g., MSG2, sync message, etc.) and each indication may be used to define whether the frequency resource which starts after sync/msg2 is contention-free or contention-based. For example, the indication may be sent using any of methods (1)-(3) below.
(1) Using an explicit indicator information element (IE) sent for each frequency. For example, MSG2 may contain an indicator for each frequency (i.e., x indicators for x frequency resources in a time occasion), where the indicator indicates either that the resource after MSG2 having the same frequency is either contention-based (i.e., available for MSG1 transmission) or contention free (not available for MSG1 transmission, reserved for MSG3 or data transmission).
(2) Using an explicit field that enumerates the contention-based or contention-free resources. For example, the field may list the frequency resources following MSG2 which may be used for MSG1 transmission (i.e., contention-based), or may list the frequency resources following MSG2 which may be used for MSG3 transmission (and are dedicated to a specific device).
(3) Implicitly, based on the presence/value of another field or information element in MSG2. For example, the echo or a random ID may indicate that a frequency is contention-free following MSG2. In one example, MSG2 may contain an ordered list of x random ID values, or a reserved value (i.e. a value not allowed to be selected as a random ID), where each of the ordered list corresponds to one of the x frequencies (e.g., in increasing/decreasing frequency/resource order). If the frequency is associated with an echoed random ID in MSG2, the frequency resource after MSG2 is contention-free and not available to a device for MSG1 transmission. If the frequency is associated with a reserved value, the frequency resource after MSG2 is contention-based and can be selected by a device for MSG1 transmission. In another example, MSG2 may contain an ordered list of tuples (frequency index, echo value). If the frequency index is listed in MSG2 with a corresponding echo value, the resource with the corresponding echo value may indicated as being contention-free in the resource after MSG2. In the above examples, and other examples herein, the device that transmitted MSG1 in a specific frequency and received an echo value in MSG2, the device may use the same frequency to transmit MSG3 after MSG2 is received. Alternatively, MSG2 may contain an indication to change to a different frequency than what was used for MSG1.

Solutions where a reader may respond to a resource request indication and/or (remaining) data size are disclosed. In one solution, a reader that receives a resource request indication and/or (remaining) data size in MSG3 may schedule a subsequent resource (e.g., starting after the next reader message, which could be a MSG2 or an occasion/sync message). Specifically, the reader may indicate that such subsequent resource is contention-free and unusable by other devices, other than the device that sent the status message.

The reader may allocate a resource based on the requested duration of a device.

Specifically, a reader, upon receiving a resource request with a size, or time indication, may transmit a first message (e.g., MSG2, sync/occasion message) followed by a second message (e.g., MSG2, sync/occasion message) where the time between the first message and the second message is:
longer than the indicated time;
a configured period of time which is associated with the data size indicated (e.g., the reader may be (pre)configured with a mapping of resource size and duration, and may ensure that the first message and the second message are spaced by at least the associated duration); and/or
a configured period of time which is associated with the data type (where data type can take on any of the forms herein).

A reader (e.g., in the case of FDM transmissions by the device, and non-FDM transmissions by the reader) may receive multiple requests from different devices. The time between the first message and the second message may be determined as the largest indicated time or the time derived for the largest data amount, the longest of the times derived for all of the data amounts, etc.

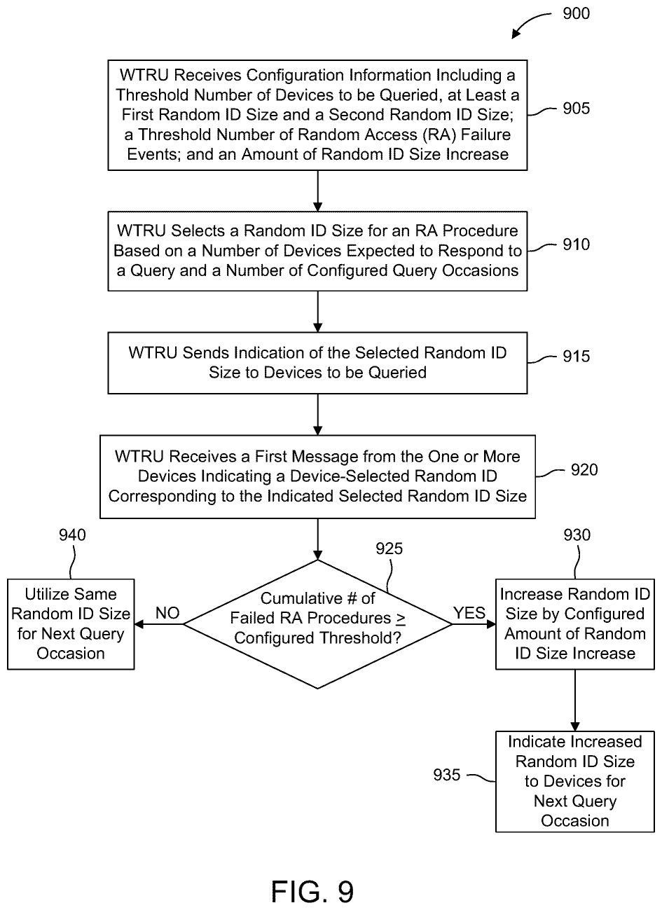

Turning to FIG. 9, an example method 900 for use by a wireless transmit receive device (WTRU) in determining a size of a device ID used by queried devices in MSG1 transmission of a random access procedure is shown. In this embodiment, a WTRU determines the size of the ID in MSG1 transmission for one or more AIoT devices based on the number of devices to be paged and/or results of previous random access procedures, and transmits the determined ID size in the paging message. Method 900 is specific to a WTRU as a reader (e.g., FIG. 4 intermediate WTRU 408 in topology 2).

Initially, the WTRU receives 905 configuration information for determining a random ID size and/or adjustment which may indicate one or more of a threshold number of devices to be inventoried/queried, at least a first random ID size and second random ID size, and/or a threshold number of random access failure events. The WTRU may also receive a configured amount (e.g., number of bits) of random ID size increase or decrease, e.g., in the form of a delta value. In certain embodiments, the threshold number of random access failure events is a set of N thresholds corresponding to a number of inventory occasions.

The WTRU selects 910 an initial random ID size to be used for a random access procedure based on the number of devices expected to respond and the number of configured inventory/query occasions. For example, given the range of the device IDs to be included in the paging message, the WTRU may determine a number of devices to be paged. The WTRU may also consider the number of query occasions which may affect the number of random IDs that might be generated.

The WTRU may then select a first random ID size if the number of devices to be paged is above a threshold, otherwise, it may select the second random ID size. Next, the WTRU may send/transmit 915 the selected random ID size to be used by the AIoT devices for their random selection of a device ID. In certain embodiments, the selected random ID size is sent in a paging message.

The WTRU receives 920 a first message, i.e., MSG1, from the one or more AIoT devices indicating a device-selected random ID having a size corresponding to the indicated selected random ID size. Additional random access messages such as MSG2, MSG3 and MSG4 previously described, may be exchanged (not shown).

In some embodiments, the WTRU may optionally change the selected random ID size in the current random access procedure/inventory based on the number of failure events to that point.

For example, if 925 the number of random access failure events meets or exceeds the configured threshold, the WTRU may increase 930 the random ID size to be used in the next inventory occasion, e.g., by the configured random size increase, and indicates 935 the new random ID size in a message initiating the next query occasion. Otherwise, the WTRU may utilize 940 the same random ID size for the next query occasion. In certain embodiments, the WTRU may alternatively decrease the random ID size. For example, if the number of cumulative failed random access events is below a configured threshold.

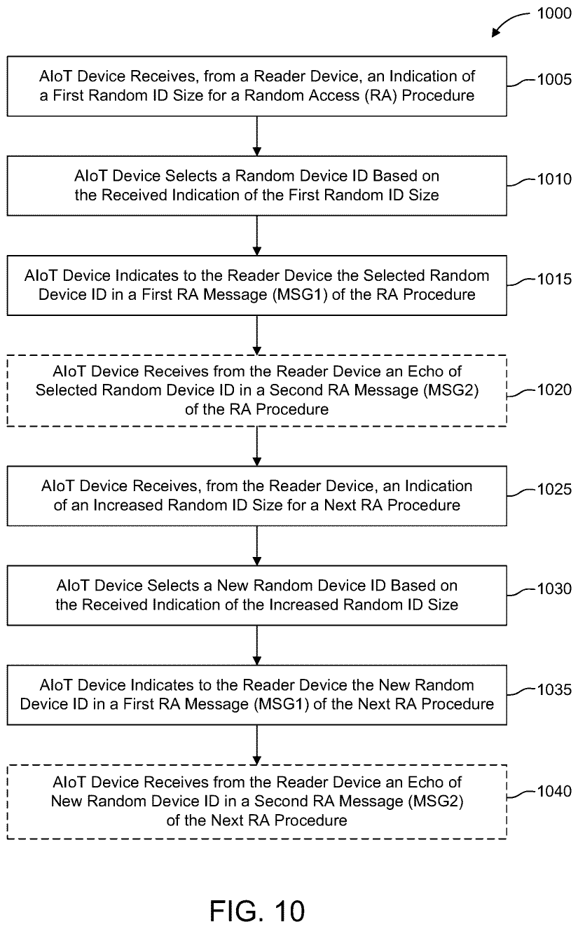

Referring to FIG. 10, an example method 1000 for an AIoT device is shown. At step 1005, the AIoT device receives 1005, from a reader device such as a WTRU, base station, etc., depending on the network topology, an indication of a first random ID size for a random access (RA) query procedure. The AIoT device randomly selects 1010 a device ID having a size based on the indicated random ID size and indicates 1015 the device ID to the reader device in a first random access message (MSG1) of the RA procedure. The AIoT device may receive 1020 an echo of the device ID in MSG2, indicating contention access is resolved. Additional messages may be exchanged (not shown) as described previously. Prior to a next query occasion, the AIoT may receive 1025 from the reader, an indication of an increased random ID size and the AIoT device randomly selects 1030 a new device ID based on the indicated increased ID size. The new device ID may be indicated 1035 to the reader in MSG1 of the next RA procedure, which may be confirmed by receiving 1040 MSG2 from the reader echoing the indicated device-selected device ID as previously described. Similar to previously described embodiments, alternatively to an increased random ID size at step 1025, a decreased random ID size may be received and the AIoT device randomly selects a new device ID based on the decreased ID size. In the case that no indication of a change in random ID size is received, the AIoT device may use the same device ID for a next query occasion.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-20. (canceled)

21. A method implemented in an internet of things (IoT) device, the method comprising:
receiving, from a reader, a paging message;
performing a random access (RA) procedure with the reader;
receiving, from the reader, a request for data and indication of a first resource for the IoT device to send the data;
sending, to the reader using the first resource, a first message including a first portion of the data and an indication that continued transmission of the data may be performed in a next occasion;
receiving, from the reader, indication or confirmation of a second resource for continued transmission of the data; and
sending, to the reader using the second resource, a second message including a second portion of the data and one of either the indication that continued transmission of the data may be performed in the next occasion, or not.

22. The method of claim 21, wherein the indication that continued transmission of the data may be performed in the next occasion comprises a single bit indicator.

23. The method of claim 21, wherein the RA procedure comprises:
in response to the paging message, transmitting to the reader in a randomly selected resource, a first RA message (MSG1) including a random ID; and
receiving, from the reader, a second RA message (MSG2) including the random ID and an allocated resource.

24. The method of claim 23, wherein the request for data is the MSG2 of the RA procedure, the allocated resource is the first resource and the first message is a third RA message (MSG3) of the RA procedure.

25. The method of claim 21, wherein the request for data is a read command received from the reader subsequent to the RA procedure.

26. The method of claim 21, wherein the indication that continued transmission of the data may be performed in the next occasion comprises an indication of a size of a remaining portion of the data requested.

27. The method of claim 21, wherein the first resource and the second resource comprise one of: a frequency resource, a time resource or a time and frequency resource.

28. The method of claim 21, wherein the IoT device comprises an ambient IoT (AIoT) device.

29. An internet of things (IoT) device comprising:
a processor; and
a radio frequency (RF) communication circuit coupled to the processor; wherein the processor and the RF communication circuit are configured to:
receive, from a reader, a paging message;
perform a random access (RA) procedure with the reader;
receive, from the reader, a request for data and an indication of a first resource for the IoT device to send the data;
send, to the reader using the first resource, a first message including a first portion of the data and an indication that continued transmission of the data may be performed in a next occasion;
receive, from the reader, indication or confirmation of a second resource for continued transmission of the data; and
send, to the reader using the second resource, a second message including a second portion of the data and one of either the indication that continued transmission of the data may be performed in the next occasion, or not.

30. The IoT device of claim 29, wherein the indication that continued transmission of the data may be performed in the next occasion comprises a single bit indicator.

31. The IoT device of claim 29, wherein to perform the RA procedure, the processor and the RF communication circuit are further configured to:
in response to the paging message, transmit to the reader in a randomly selected resource, a first RA message (MSG1) including a random ID; and
receive, from the reader, a second RA message (MSG2) including the random ID and an allocated resource.

32. The IoT device of claim 31, wherein the request for data is the MSG2 of the RA procedure, the allocated resource is the first resource and the first message is a third RA message (MSG3) of the RA procedure.

33. The IoT device of claim 29, wherein the request for data is a read command received from the reader subsequent to the RA procedure.

34. The IoT of claim 29, wherein the indication that continued transmission of the data may be performed in the next occasion comprises an indication of a size of a remaining portion of the data requested.

35. The IoT device of claim 29, wherein the first resource and the second resource comprise one of: a frequency resource, a time resource or a time and frequency resource.

36. The IoT device of claim 29, wherein the IoT device comprises and ambient IoT (AIoT) device.
